(19) United States
(12) Patent Application Publication
(10) Pub. No.: US 2018/0054049 A1
(43) Pub. Date: Feb. 22, 2018

(54) INSERT DEVICE TO BE INSERTED INTO OR WITHDRAWN OUT OF HOLLOW ELECTRICAL-DEVICE FRAME BURIED IN WALL IN BUILDING CONSTRUCTION

(71) Applicant: SUN KI KIM, Yeongju-si (KR)

(72) Inventor: KWANG SOO KIM, Yeongju-si (KR)

(21) Appl. No.: 15/629,784

(22) Filed: Jun. 22, 2017

(30) Foreign Application Priority Data
Aug. 19, 2016 (KR) 20-2016-0004818

(51) Int. Cl. H02G 3/08; H02G 3/14; H02G 3/10

(52) U.S. Cl. CPC H02G 3/081; H02G 3/10; H02G 3/14

(57) ABSTRACT

There is provided an insert device configured be inserted into or withdrawn out of a hollow electrical-device frame buried in a wall in a building construction, the device comprising: an inserted portion configured to be inserted into or withdrawn out of the hollow electrical-device frame buried in the wall; and a grip portion coupled to the inserted portion, wherein the grip portion is configured to be gripped by an user to allow the inserted portion to be withdrawn out of the frame, wherein the inserted portion has a size and a shape such that the inserted portion is in close contact with an entire inner surface of the hollow electrical-device frame.

### CROSS-REFERENCE TO RELATED APPLICATION

This application claims the benefit of Korean Utility Model Application No. 20-2016-004818 filed on Aug. 19, 2016, in the Korean Intellectual Property Office, the entire disclosure of which is incorporated herein by reference for all purposes.

### BACKGROUND

### Technical Field

The present disclosure relates to an insert device to be inserted into or withdrawn out of a hollow electrical-device frame buried in a wall in a building construction.

### Related Art

The interior wall of a typical building has a box buried therein in which a switch or an electrical outlet for turning on and off an illuminating lamp is installed. In addition, household distribution boards, distribution boards, communication terminal boxes, etc. are also embedded in the interior walls of buildings in the form of boxes. Hereinafter, the switch box, the outlet box, the household distribution board, the distribution board, and the communication terminal box are collectively referred to as a box or a hollow electrical-device frame.

On the other hand, when constructing a concrete or brick building, the interior wall is finished with a general plastering work. As mentioned above, the switch box, the outlet box, the household distribution panel, the distribution panel, and the communication terminal box is fixed to the wall in advance before the plastering work. Through the finishing work, the boxes may be completely fixed, and, and the walls are finished with paint or wallpaper.

When a plastering operation is performed in a state in which the box is embedded, cement or sand often enters the inside of the box. Sometimes, boxes can be hidden. Therefore, there is considerable difficulty in finding the box later. When the cement is cured in the box, it is not easy to remove the cured cement therefrom. However, plastering the wall carefully so as to non-contact the box greatly reduces the efficiency of the work.

Conventionally, therefore, the inside of a box has been protected by putting newspapers or work gloves or tapes in a box. However, it is cumbersome to block many boxes one by one. Also, there are cases where the box cannot be completely blocked. The worker may waste a lot of time because the worker cannot find a stuff to fill the box.

### PRIOR ART DOCUMENT

### Patent Literature

Patent Document 1: Korean Utility Model Application No. 20-2009-0010755; and
Patent Document 2: Korean Patent Application No. 10-2006-0055981

### SUMMARY

This Summary is provided to introduce a selection of concepts in a simplified form that are further described below in the Detailed Description. This Summary is not intended to identify all key features or essential features of the claimed subject matter, nor is it intended to be used alone as an aid in determining the scope of the claimed subject matter.

It is an object of the present disclosure to prevent cement from entering into the hollow electrical-device frame when performing a plastering operation in a state where the hollow electrical-device frame is buried in a wall when constructing a building. It is a specific object of the present disclosure to provide hollow electrical-device frame protecting means which can protect the hollow electrical-device frame from cement or sand to enable electric construction or plastering work to be carried out quickly or easily.

In one aspect of the present disclosure, there is provided an insert device configured be inserted into or withdrawn out of a hollow electrical-device frame buried in a wall in a building construction, the device comprising: an inserted portion configured to be inserted into or withdrawn out of the hollow electrical-device frame buried in the wall; and a grip portion coupled to the inserted portion, wherein the grip portion is configured to be gripped by an user to allow the inserted portion to be withdrawn out of the frame.

In one implementation, the inserted portion has a size and a shape such that the inserted portion is in close contact with an entire inner surface of the hollow electrical-device frame.

In one implementation, the inserted portion is made of a material selected from a group consisting of urethane, closed-cell extruded polystyrene foam, rubber, or PVC.

In one implementation, the inserted portion is fitted such that a front face thereof protrudes slightly from an open front face of the hollow electrical-device frame, or the inserted portion is fitted such that a front face of the inserted portion is flush with an open front face of the hollow electrical-device frame.

In one implementation, the inserted portion is filled with air and is made of an elastic material and has a form of a tube or a balloon which can be freely changed in shape.

In one implementation, the grip portion and the inserted portion are made of different materials.

In one implementation, the grip portion protrudes outwardly from the frame to block the front open face of the hollow electrical-device frame when the inserted portion has been inserted into the frame; or the grip portion has at least two grooves defined in a front face portion thereof; or the grip portion has a knob strap having knots at both ends thereof.

In accordance with the present disclosure, the insert device may prevent cement from entering into the hollow electrical-device frame when performing a plastering operation in a state where the hollow electrical-device frame is buried in a wall when constructing a building. Thus, this allows the electric construction or plastering work to be carried out quickly or easily.

### BRIEF DESCRIPTION OF THE DRAWINGS

The accompanying drawings, which are incorporated in and form a part of this specification and in which like numerals depict like elements, illustrate embodiments of the present disclosure and, together with the description, serve to explain the principles of the disclosure.

FIG. 1 shows a perspective view of a hollow electrical-device frame buried in a wall in a building construction and an insert device to be inserted into or withdrawn out of the hollow electrical-device frame buried in a wall in a building construction, in accordance with one embodiment of the present disclosure.

FIG. 2 shows a side elevation view of a hollow electrical-device frame buried in a wall in a building construction and an insert device to be inserted into or withdrawn out of the hollow electrical-device frame buried in a wall in a building construction, in accordance with one embodiment of the present disclosure.

FIG. 3 shows a perspective view of an insert device to be inserted into or withdrawn out of the hollow electrical-device frame buried in a wall in a building construction, in accordance with another embodiment of the present disclosure.

FIG. 4 shows a perspective view of a hollow electrical-device frame buried in a wall in a building construction and an insert device to be inserted into or withdrawn out of the hollow electrical-device frame buried in a wall in a building construction, in accordance with still another embodiment of the present disclosure.

FIG. 5 shows a perspective view of an insert device to be inserted into or withdrawn out of the hollow electrical-device frame buried in a wall in a building construction, in accordance with still another embodiment of the present disclosure.

FIG. 6 shows a side elevation view of a state in which an insert device is inserted into the hollow electrical-device frame buried in a wall in a building construction, in accordance with one embodiment of the present disclosure.

For simplicity and clarity of illustration, elements in the figures are not necessarily drawn to scale. The same reference numbers in different figures denote the same or similar elements, and as such perform similar functionality. Also, descriptions and details of well-known steps and elements are omitted for simplicity of the description. Furthermore, in the following detailed description of the present disclosure, numerous specific details are set forth in order to provide a thorough understanding of the present disclosure. However, it will be understood that the present disclosure may be practiced without these specific details. In other instances, well-known methods, procedures, components, and circuits have not been described in detail so as not to unnecessarily obscure aspects of the present disclosure.

### DETAILED DESCRIPTIONS

Examples of various embodiments are illustrated and described further below. It will be understood that the description herein is not intended to limit the claims to the specific embodiments described. On the contrary, it is intended to cover alternatives, modifications, and equivalents as may be included within the spirit and scope of the present disclosure as defined by the appended claims.

It will be understood that, although the terms “first”, “second”, “third”, and so on may be used herein to describe various elements, components, regions, layers and/or sections, these elements, components, regions, layers and/or sections should not be limited by these terms. These terms are used to distinguish one element, component, region, layer or section from another element, component, region, layer or section. Thus, a first element, component, region, layer or section described below could be termed a second element, component, region, layer or section, without departing from the spirit and scope of the present disclosure.

It will be understood that when an element or layer is referred to as being “connected to”, or “coupled to” another element or layer, it can be directly on, connected to, or coupled to the other element or layer, or one or more intervening elements or layers may be present. In addition, it will also be understood that when an element or layer is referred to as being “between” two elements or layers, it can be the only element or layer between the two elements or layers, or one or more intervening elements or layers may also be present.

Spatially relative terms, such as “beneath,” “below,” “lower,” “under,” “above,” “upper,” and the like, may be used herein for ease of explanation to describe one element or feature's relationship to another element s or feature s as illustrated in the figures. It will be understood that the spatially relative terms are intended to encompass different orientations of the device in use or in operation, in addition to the orientation depicted in the figures. For example, if the device in the figures is turned over, elements described as “below” or “beneath” or “under” other elements or features would then be oriented “above” the other elements or features. Thus, the example terms “below” and “under” can encompass both an orientation of above and below. The device may be otherwise oriented for example, rotated 90 degrees or at other orientations, and the spatially relative descriptors used herein should be interpreted accordingly.

The terminology used herein is for the purpose of describing particular embodiments only and is not intended to be limiting of the present disclosure. As used herein, the singular forms “a” and “an” are intended to include the plural forms as well, unless the context clearly indicates otherwise. It will be further understood that the terms “comprises”, “comprising”, “includes”, and “including” when used in this specification, specify the presence of the stated features, integers, operations, elements, and/or components, but do not preclude the presence or addition of one or more other features, integers, operations, elements, components, and/or portions thereof. As used herein, the term “and/or” includes any and all combinations of one or more of the associated listed items. Expression such as “at least one of” when preceding a list of elements may modify the entire list of elements and may not modify the individual elements of the list.

Unless otherwise defined, all terms including technical and scientific terms used herein have the same meaning as commonly understood by one of ordinary skill in the art to which this inventive concept belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

In the following description, numerous specific details are set forth in order to provide a thorough understanding of the present disclosure. The present disclosure may be practiced without some or all of these specific details. In other instances, well-known process structures and/or processes have not been described in detail in order not to unnecessarily obscure the present disclosure.

As used herein, the term “substantially,” “about,” and similar terms are used as terms of approximation and not as terms of degree, and are intended to account for the inherent deviations in measured or calculated values that would be recognized by those of ordinary skill in the art. Further, the use of “may” when describing embodiments of the present disclosure refers to “one or more embodiments of the present disclosure.”

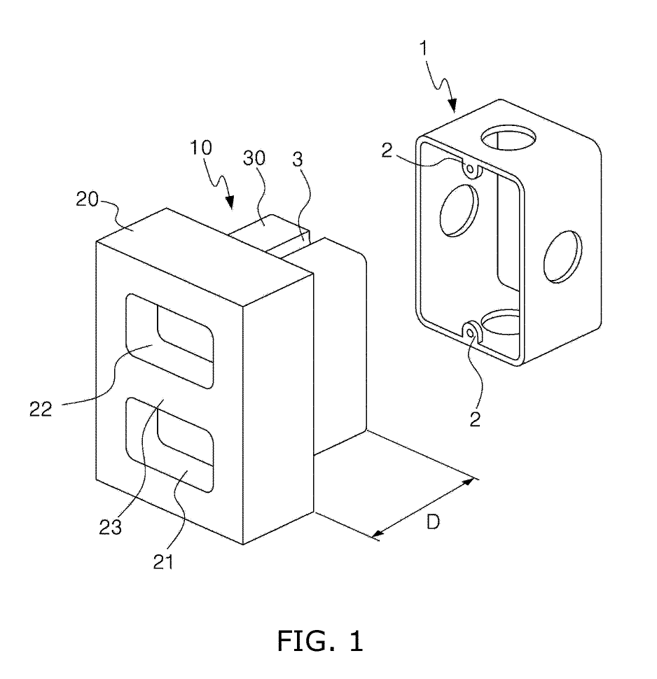

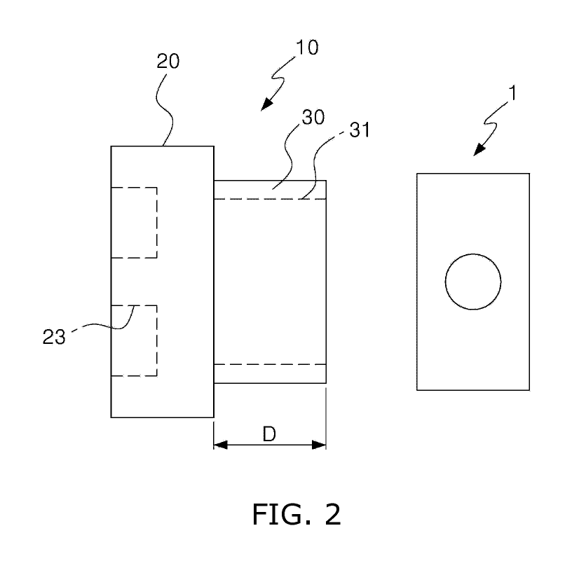

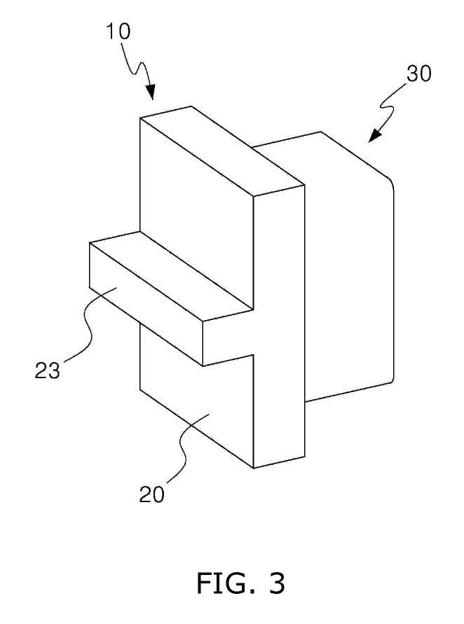

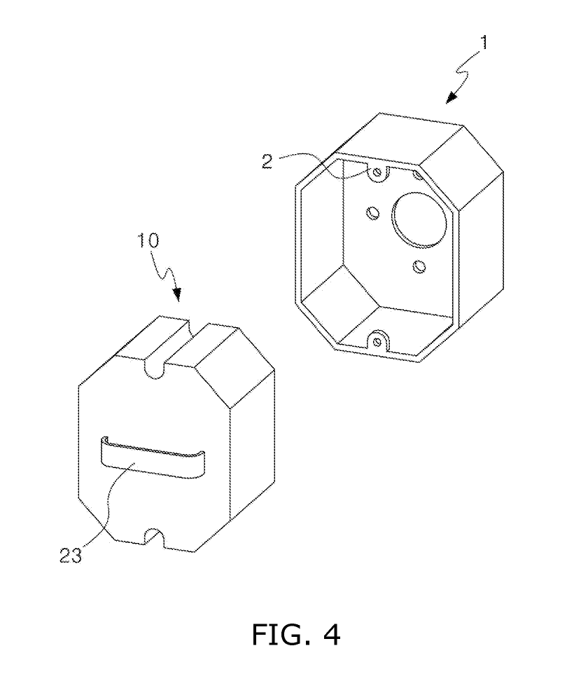

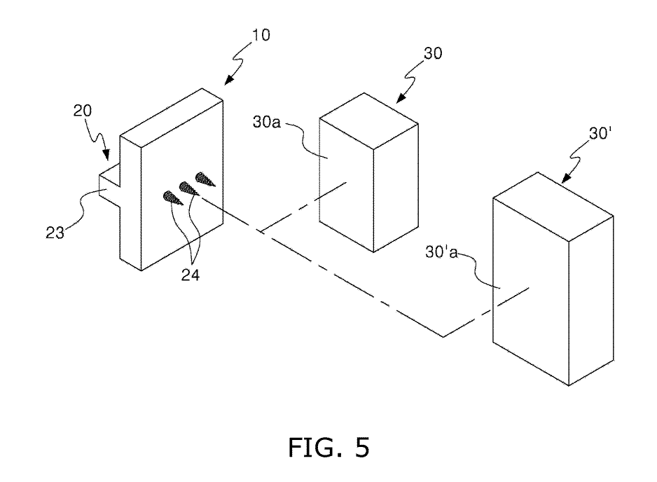

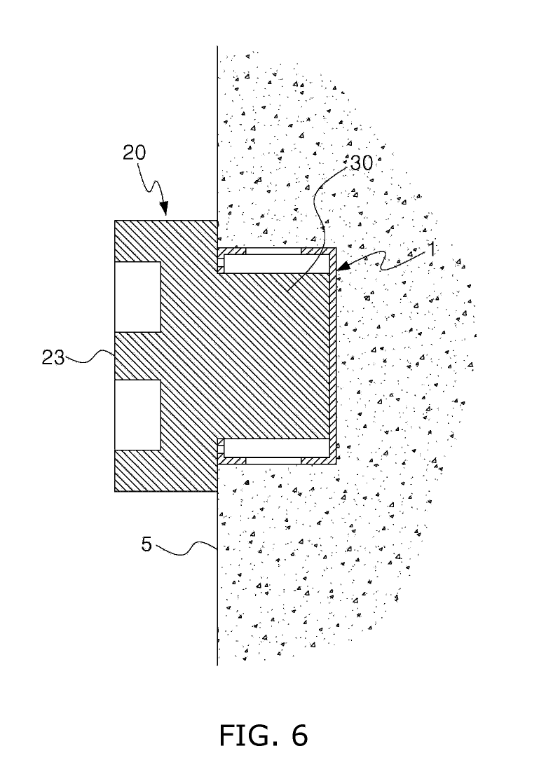

FIG. 1 shows a perspective view of a hollow electrical-device frame buried in a wall in a building construction and an insert device to be inserted into or withdrawn out of the hollow electrical-device frame buried in a wall in a building construction, in accordance with one embodiment of the present disclosure. FIG. 2 shows a side elevation view of a hollow electrical-device frame buried in a wall in a building construction and an insert device to be inserted into or withdrawn out of the hollow electrical-device frame buried in a wall in a building construction, in accordance with one embodiment of the present disclosure. FIG. 3 shows a perspective view of an insert device to be inserted into or withdrawn out of the hollow electrical-device frame buried in a wall in a building construction, in accordance with another embodiment of the present disclosure. FIG. 4 shows a perspective view of a hollow electrical-device frame buried in a wall in a building construction and an insert device to be inserted into or withdrawn out of the hollow electrical-device frame buried in a wall in a building construction, in accordance with still another embodiment of the present disclosure. FIG. 5 shows a perspective view of an insert device to be inserted into or withdrawn out of the hollow electrical-device frame buried in a wall in a building construction, in accordance with still another embodiment of the present disclosure. FIG. 6 shows a side elevation view of a state in which an insert device is inserted into the hollow electrical-device frame buried in a wall in a building construction, in accordance with one embodiment of the present disclosure.

The insert device 10 to be inserted into or withdrawn out of a hollow electrical-device frame 1 buried in a wall 5 in a building construction may include an inserted portion 30 be inserted into or withdrawn out of the hollow electrical-device frame 1 buried in the wall 5, and a grip portion 20 coupled to the inserted portion 30 and protruding outwardly from the inserted portion 30 when the inserted portion has been inserted into the frame 1, wherein the grip portion 20 is configured to be gripped by an user to withdrawn out of the frame.

The inserted portion 30 is closely fitted into the hollow electrical-device frame 1 and is held therein by the frictional force. The portion 30 is closely fitted so that there is no gap in the hollow electrical-device frame 1. To this end, the inserted portion 30 is formed to conform to the shape of the hollow electrical-device frame 1. For example, when the hollow electrical-device frame 1 is provided with a protrusion 2, a groove 31 in which the protrusion 2 fits should be provided. The inserted portion 30 may vary in size or shape. For example, the planar shape thereof may be a square, a rectangle, or an octagon (FIG. 4). Its height D may also be determined by the depth of the hollow electrical-device frame 1.

According to an embodiment of the present disclosure, the inserted portion 30 has a size and a shape such that it is in close contact with the entire inner surface of the hollow electrical-device frame. Thus, the portion 30 may be made of a material such as urethane, closed-cell extruded polystyrene foam, rubber, or PVC, etc. The inserted portion 30 may be fitted so as to protrude slightly from the hollow electrical-device frame 1. Alternatively, the portion 30 may be fitted therein so that it does not have any step with the hollow electrical-device frame. A selection between the former and latter cases may depend on a material of the inserted portion 30 and/or convenience of a plastering work.

Referring to FIG. 1, the grip portion 20 is formed to cover the opening of the hollow electrical-device frame 1 like a cap. That is, the plane of the grip portion 20 is wider than the plane of the hollow electrical-device frame 1, so that the hollow electrical-device frame 1 can be completely covered.

The knob 23 of the grip portion 20 may protrude outwardly from the body of the portion 20 as shown in FIG. 3. However, the present disclosure is not limited thereto. In one embodiment, in order to prevent breakage thereof in the plastering work, as shown FIG. 1 to FIG. 2, two grooves 21 and 22 may be inwardly recessed in the body of the portion 20.

The knob 23 of the grip portion 20 may be provided in a variety of ways. The inserted portion 30 and the portion 20 may be made of different materials. In one example, the inserted portion 30 may be made of a material such as a urethane, closed-cell extruded polystyrene foam, rubber, or PVC, etc. so that the hollow electrical-device frame 1 is in close contact with the entire inner surface. The knob 23 as shown in FIG. 4 may be embodied with a string installed on the inserted portion. In FIG. 4, the string is a wide and planar cord, but it may be an elongate cord or rope. In the latter case, the knob 23 may have knots at the ends thereof and, thus, can be easily pulled by hand.

According to another embodiment of the present disclosure, as shown in FIG. 5, the inserted portions 30 or 30′ and the grip portion 20 may made of different materials, and they may be detachable from each other. In one embodiment, the grip portion 20 may be made of wood or synthetic resin. The fixing means such as nails 24 may be installed on the grip portion. The grip portion 20 is then selectively coupled to the inserted portion 30 or 30′ made of the closed-cell extruded polystyrene foam using nails 24. The grip portion 20 is selectively engaged with the inserted portions 30 or 30′ as the nail 24 is pushed into the mating surfaces 30a or 30′a of the inserted portion 30. In this case, first, the inserted portion corresponding to the shape of the hollow electrical-device frame 1 is selected, for example, between the portions 30 or 30′, and then the grip portion 20 is fixed to the selected inserted portion using the nails. That is, the grip portion 20 is used generally, and only the inserted portion is replaced to be conformed to the specific frame 1.

According to another embodiment of the present disclosure, the inserted portion is filled with air and is made of an elastic material. Therefore, it may be in the form of a rubber ball, a tube or a balloon which can be freely changed in shape. The inserted portion can be easily gripped and fitted into the frame and pulled out of the frame by hand. Thus, in the case of this embodiment, the grip portion and the inserted portion are formed integrally. The inserted portion in such an embodiment would have to be provided in such a thickness that it would not rupture easily by the corners of the metal protruding into the interior of the hollow electrical-device frame.

It is to be understood that while the present disclosure has been particularly shown and described with reference to the exemplary embodiments thereof, the disclosure is not limited to the disclosed exemplary embodiments. On the contrary, it will be understood by those skilled in the art that various modifications may be made without departing from the spirit and scope of the present disclosure.

It is understood by those skilled in the art that various variants and alternatives may be selected in the present disclosure without departing from the spirit or scope of the present disclosure. Accordingly, it is intended that the present disclosure covers the modifications and variations when they come within the scope of the appended claims and their equivalents.

In the present specification, a reference has been made to all the device and method disclosures. In this connection, the descriptions of the device and method disclosures may be applied to each other in a supplementing manner.

What is claimed is:

1. An insert device configured be inserted into or withdrawn out of a hollow electrical-device frame buried in a wall in a building construction, the device comprising:
an inserted portion configured to be inserted into or withdrawn out of the hollow electrical-device frame buried in the wall; and
a grip portion coupled to the inserted portion, wherein the grip portion is configured to be gripped by an user to allow the inserted portion to be withdrawn out of the frame,
wherein the inserted portion has a size and a shape such that the inserted portion is in close contact with an entire inner surface of the hollow electrical-device frame,
wherein the inserted portion is made of a material selected from a group consisting of urethane, closed-cell extruded polystyrene foam, rubber, or PVC,
wherein the inserted portion is fitted such that a front face thereof protrudes slightly from an open front face of the hollow electrical-device frame, or the inserted portion is fitted such that a front face of the inserted portion is flush with an open front face of the hollow electrical-device frame,
wherein the inserted portion is filled with air and is made of an elastic material and has a form of a tube or a balloon which can be freely changed in shape,
wherein the grip portion and the inserted portion are made of different materials,
wherein the grip portion protrudes outwardly from the frame to block the front open face of the hollow electrical-device frame when the inserted portion has been inserted into the frame; or the grip portion has at least two grooves defined in a front face portion thereof; or the grip portion has a knob strap having knots at both ends thereof.
